(19) United States
(12) Patent Application Publication
(10) Pub. No.: US 2016/0328699 A1
(43) Pub. Date: Nov. 10, 2016

(54) METHOD AND APPARATUS FOR PROCESSING DATA

(71) Applicant: TENCENT TECHNOLOGY (SHENZHEN) COMPANY LIMITED, Shenzhen (CN)

(72) Inventors: Rong CHEN, Shenzhen (CN); Meng CHEN, Shenzhen (CN); Yuanbin CHEN, Shenzhen (CN); Kuan LIU, Shenzhen (CN); Liang DONG, Shenzhen (CN); Dechun LI, Shenzhen (CN); Feifei LIU, Shenzhen (CN); Chuansheng YU, Shenzhen (CN)

(73) Assignee: TENCENT TECHNOLOGY (SHENZHEN) COMPANY LIMITED, Shenzhen (CN)

(21) Appl. No.: 15/214,848

(22) Filed: Jul. 20, 2016

Related U.S. Application Data
(63) Continuation of application No. PCT/CN2015/094360, filed on Nov. 12, 2015.

(30) Foreign Application Priority Data
Nov. 19, 2014 (CN) 201410664933.0

(51) Int. Cl. G06Q 20/32; G06Q 20/40; H04W 4/02; G06Q 20/38

(52) U.S. Cl. CPC G06Q 20/3224; G06Q 20/382; G06Q 20/40; H04W 4/023

(57) ABSTRACT

A method and an apparatus for processing data are provided. The method includes: receiving, through a network, a data processing request sent by a first device, where the first device is connected to the network via a wireless access point; obtaining a distance value between the first device and the wireless access point in a case that the wireless access point is a credit access point for the first device; calculating, based on the distance value between the first device and the wireless access point, a credit value associated with the first device in a case that the distance value exceeds a preset distance threshold; and accepting the data processing request in a case that the credit value is greater than or equal to a credit threshold.

This application is a continuation of International Application No. PCT/CN2015/094360, filed on Nov. 12, 2015, which claims the priority to Chinese Patent Application No. 201410664933.0, titled “METHOD FOR TRANSFERRING DATA, RELATED DEVICE AND SYSTEM”, filed on Nov. 19, 2014 with the State Intellectual Property Office of the PRC, both of which are incorporated herein by reference in their entireties.

### TECHNICAL FIELD

The present disclosure relates to the field of internet technology, and particularly to a method and an apparatus for processing data.

### BACKGROUND

With the rapid development of internet technology, performing mobile payments with clients such as smart phones, tablet computers, palmtop computers and mobile internet devices (MID) becomes a fashionable and popular payment manner. In practice, in a case that a user performs mobile payment on a client, the user needs to manually input a payment password to the client, to complete an operation of the mobile payment, which not only makes the operation of the mobile payment complex but also causes a big threat to security of the mobile payment for there is a risk that the payment password may be stolen.

### SUMMARY

A method for processing data is provided according to embodiments of the present disclosure. The method for processing data includes:

receiving, by a second device through a network, a data processing request sent by a first device, where the first device is connected to the network via a wireless access point;

determining whether the wireless access point is a credit access point for the first device;

obtaining a distance value between the first device and the wireless access point in a case that the wireless access point is the credit access point for the first device;

determining whether the distance value exceeds a preset distance threshold;

calculating, based on the distance value between the first device and the wireless access point, a credit value associated with the first device in a case that the distance value exceeds the preset distance threshold;

determining whether the credit value is greater than or equal to a credit threshold; and

processing, by the second device, the data in a case that the credit value is greater than or equal to the credit threshold.

An apparatus for processing data is further provided according to embodiments of the present disclosure. The apparatus for processing data includes a memory and one or more processors, where program instructions are stored in the memory, and when the program instructions are executed by the one or more processors, the program instructions configure the apparatus to perform operations including:

receiving, through a network, a data processing request sent by a first device, where the first device is connected to the network via a wireless access point;

determining whether the wireless access point is a credit access point for the first device;

obtaining a distance value between the first device and the wireless access point in a case that the wireless access point is the credit access point for the first device;

determining whether the distance value exceeds a preset distance threshold;

calculating, based on the distance value between the first device and the wireless access point, a credit value associated with the first device in a case that the distance value exceeds the preset distance threshold;

determining whether the credit value is greater than or equal to a credit threshold; and

processing, the data in a case that the credit value is greater than or equal to the credit threshold.

According to the embodiments of the present disclosure, after determining that the access point is the credit access point for the first device (for example, a client), the second device (for example, a service terminal) may obtain the distance value between the first device and the access point and perform operations for processing the data in a case that the distance value exceeds the preset distance threshold and the credit value of the first device is greater than or equal to the credit threshold. As can be seen that, with the embodiments of the present disclosure, there is no need to input a password to a user device, which simplifies the operations and improves efficiency. In addition, with the embodiments of the present disclosure, passwords can be effectively prevented from being stolen and security can be improved.

### BRIEF DESCRIPTION OF THE DRAWINGS

The drawings to be used in the descriptions of embodiments are described briefly as follows, so that technical solutions according to the embodiments of the disclosure may become clearer. The drawings in the following descriptions only illustrate some embodiments of the disclosure. For those skilled in the art, other drawings may be obtained based on these drawings without any creative work.

FIG. 1 is a flowchart of a method for processing data according to an embodiment of the disclosure;

FIG. 2 is a flowchart of a method for processing data according to another embodiment of the disclosure;

FIG. 3 is a schematic block diagram of a service terminal according to an embodiment of the disclosure;

FIG. 4 is a schematic block diagram of a service terminal according to another embodiment of the disclosure; and

FIG. 5 is a schematic block diagram of a system for processing data according to an embodiment of the disclosure.

### DETAILED DESCRIPTION

Technical solutions according to the embodiments of the disclosure are described in conjunction with the drawings. The described embodiments are only a few rather than all of the embodiments of the invention. Any other embodiments obtained by those skilled in the art based on the embodiments according to the present disclosure without any creative work fall in the protection scope of the present claims.

A method and an apparatus for processing data are provided according to the embodiments of the present disclosure. With the embodiments of the present disclosure, there is no need to input a password to a user device, which simplifies the operations and improves efficiency. In addition, with the embodiments of the present disclosure, passwords can be effectively prevented from being stolen and security of a mobile application can be improved. The method and the apparatus are described in detail hereinafter.

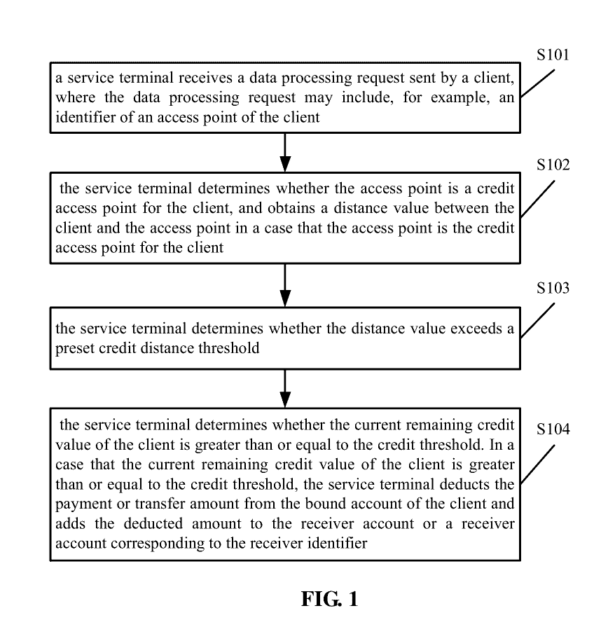

FIG. 1, is a flowchart of a method for processing data according to an exemplary embodiment of the disclosure. The method described in FIG. 1 may be applied to, for example, mobile online shopping or mobile online money transferring. As shown in FIG. 1, the method for processing data may include steps S101 to S104.

In step S101, a service terminal receives a data processing request sent by a client, where the data processing request may include, for example, an identifier of an access point of the client.

The service terminal may be a device or system such as a server, a service system or a third-party payment platform, which is not limited in the embodiment of the disclosure.

The client may be a payment client application, or a user device on which a payment client application is run, such as a smart phone, a tablet computer, a palmtop computer, an IPAD or a mobile internet device (MID).

For example, the service terminal and the client may be connected to each other through a network. The client is connected to the network via the access point.

The access point above may be a wireless access point such as a wireless router in a house of a user or a wireless router in a car of the user. The identifier of the access point may generally include a MAC address of the access point, a name of the access point and a machine identification code of the access point, which is not limited in the embodiment of the disclosure. The client and the access point may be wirelessly connected to each other, for example, via WiFi, Bluetooth or NFC.

The data processing request may be a payment request or a transfer request, for example. And the data processing request may include a payment amount (or a transfer amount) and a receiver identifier (or a receiver account). The receiver identifier may be also called a recipient identity identifier. The receiver identifier may include a company name and a personal name of a receiver. Furthermore, the data processing request may further include detailed information, such as an order number and product information.

In a scenario of mobile online shopping, the user may log into a shopping platform through a shopping entrance provided by the client, and select a product labeled with price information in the shopping platform. Accordingly, the shopping platform may detect the product, selected by the user, labeled with the price information, calculate a payment or transfer amount based on the price information of the selected product, and send information such as the payment or transfer amount and a receiver identifier corresponding to the selected product to the client. Accordingly, the client displays a screen for displaying the payment or transfer amount and the receiver identifier, the screen may include a sending menu. Furthermore, the user may perform an operation, such as a single click, on the sending menu, to trigger the client to obtain the identifier of the access point to which the client accesses, and the client generates the data processing request and sends the data processing request to the service terminal.

In step S102, the service terminal determines whether the access point is a credit access point for the client, and obtains a distance value between the client and the access point in a case that the access point is the credit access point for the client.

In the embodiment of the disclosure, the service terminal may store an identifier of the credit access point for the client in advance. In this way, after the service terminal receives the data processing request including the identifier of the access point of the client sent by the client, the service terminal may determine whether the identifier of the access point included in the data processing request is identical with the identifier of the credit access point for the client. In a case that the identifier of the access point included in the data processing request is identical with the identifier of the credit access point for the client, it is determined that the access point is the credit access point for the client. In a case that the identifier of the access point included in the data processing request is not identical with the identifier of the credit access point for the client, it is determined the access point is not the credit access point for the client.

In an embodiment, in a case that the client and the access point each are provided with a locating function (for example, a GPS locating function), the service terminal obtaining the distance value between the client and the access point in step S102 above may include the following steps S11 to S13.

In step S11, the service terminal sends a location obtaining instruction to each of the client and the access point.

In step S12, the service terminal receives location information of the client sent by the client in response to the location obtaining instruction and location information of the access point sent by the access point in response to the location obtaining instruction.

In step S13, the service terminal calculates the distance value between the client and the access point based on the location information of the client and the location information of the access point.

In the embodiment of the disclosure, the location information above may include latitude and longitude coordinates.

In another embodiment, in a case that the client can start smart distance value measuring application software, the service terminal obtaining the distance value between the client and the access point in step S102 above may include the following steps S21 and S22.

In step S21, the service terminal sends a distance value obtaining instruction to the client, to trigger the client to obtain the distance value between the client and the access point in response to the distance value obtaining instruction.

In step S22, the service terminal receives the distance value between the client and the access point sent by the client.

In the embodiment of the disclosure, the client may start the smart distance value measuring application software (for example, Smart Distance) in response to the distance value obtaining instruction, to detect the distance value between the client and the access point with the smart distance value measuring application software, where Smart Distance is an application for measuring distance values with a camera.

In the embodiment of the disclosure, in a case that the service terminal determines that the access point is not the credit access point for the client, the service terminal may request the client to send to-be-verified information, and verify whether the to-be-verified information sent by the client is identical with authorization verification information stored in the service terminal. In a case that the to-be-verified information is identical with the authorization verification information, the service terminal accepts the data processing request. For example, the service terminal deducts the payment or transfer amount from a bound account of the client and adds the deducted amount to the receiver account corresponding to the receiver identifier. In a case that the to-be-verified information is not identical with the authorization verification information, the service terminal prompts the client that the to-be-verified information fails to pass the verification, and denies the data processing request.

The to-be-verified information above may be, for example, any one of or combination of a to-be-verified password, to-be-verified fingerprint information, to-be-verified facial information, to-be-verified iris information, to-be-verified retina information and to-be-verified voiceprint information.

In step S103, the service terminal determines whether the distance value exceeds a preset credit distance threshold (also called a distance threshold).

According to an embodiment of the disclosure, the service terminal calculates a credit threshold corresponding to the payment or transfer amount based on a credit value required for paying or transferring per unit of amount in a case that the distance value exceeds the preset credit distance threshold.

In the embodiment of the disclosure, the credit distance threshold above is set by a user of the client at the service terminal in advance (for example, the user may set the credit distance threshold by setting the credit value required for paying or transferring per unit of amount). Furthermore, the user of the client may set an initial credit value CMAX at the service terminal in advance. When the client moves in an area with the credit access point as a center and the credit distance threshold as a radius, a current remaining credit value of the client (i.e., a credit value of the user of the client) is equal to the initial credit value CMAX. When the client moves outside the area with the credit access point as the center and the credit distance threshold as the radius, the current remaining credit value of the client decreases as the distance value and time increase, i.e., the current remaining credit value of the client is less than the initial credit value CMAX in this case.

In the embodiment of the disclosure, the service terminal may calculate a product of the credit value required for paying or transferring per unit of amount and the payment or transfer amount as the credit threshold.

In the embodiment of the disclosure, a case that the service terminal determines that the distance value exceeds the preset credit distance threshold will be described in following embodiments.

In step S104, the service terminal determines whether the current remaining credit value of the client is greater than or equal to the credit threshold. In a case that the current remaining credit value of the client is greater than or equal to the credit threshold, the service terminal deducts the payment or transfer amount from the bound account of the client and adds the deducted amount to the receiver account or a receiver account corresponding to the receiver identifier.

In a case that the service terminal determines that the distance value does not exceed the preset credit distance threshold in step S103 above, the current remaining credit value of the client is equal to the initial credit value CMAX set by the user of the client at the service terminal in advance. In this case, the service terminal may determine whether the current remaining credit value of the client (equal to the initial credit value CMAX) is greater than or equal to the credit threshold. In a case that the current remaining credit value of the client is greater than or equal to the credit threshold, the service terminal deducts the payment or transfer amount from the bound account of the client and adds the deducted amount to the receiver account or a receiver account corresponding to the receiver identifier, thereby achieving payment or transfer processing between the bound account of the client and the receiver account.

The bound account of the client may be, for example, a smart card account, or an electronic account provided by a third-party payment platform such as Alipay, Paypal, Tenpay, Shanghai Kuaiqian, Chinabank Payments and Payease, which is not limited in the embodiment of the disclosure.

The receiver account may be a smart card account, or an electronic account provided by a third-party payment platform such as Alipay, Paypal, Tenpay, Shanghai Kuaiqian, Chinabank Payments and Payease, which is not limited in the embodiment of the disclosure.

In the method described in FIG. 1, after determining that the access point is the credit access point for the client, the service terminal may obtain the distance value between the client and the access point and perform operations for processing the data in a case that it is determined that the distance value exceeds the preset credit distance threshold and the current remaining credit value of the client is greater than or equal to the credit threshold. As can be seen that, with the method described in FIG. 1, there is no need to manually input a payment password to the client, which simplifies the operations of mobile payment and improving efficiency of the mobile payment. In addition, with the method described in FIG. 1, the payment password can be effectively prevented from being stolen and security of the mobile payment can be improved.

Mobile online shopping or mobile online transferring is only an example of application of the method for processing data according to the embodiment of the disclosure, and the method for processing data according to the embodiment of the disclosure may also be applied to, for example, data transmission. For the data transmission, the service terminal may calculate a product of a credit value required for transmitting per unit of data and the quantity of to-be-transmitted data as the credit threshold.

According to another embodiment, the credit threshold is not related to the payment or transfer amount or the quantity of the to-be-transmitted data, and may be any value set by the user.

According to another embodiment, the credit threshold is less than the initial credit value CMAX. In this case, the service terminal may directly accept the data processing request and processing the data after the service terminal determines that the distance value between the client and the access point is less than the preset credit distance threshold.

According to another embodiment, after the service terminal determines that the distance value does not exceed the preset credit distance threshold in step S103, the service terminal directly deducts the payment or transfer amount from the bound account of the client, and adds the deducted amount to the receiver account or a receiver account corresponding to the receiver identifier, without determining whether the current remaining credit value of the client is greater than or equal to the credit threshold.

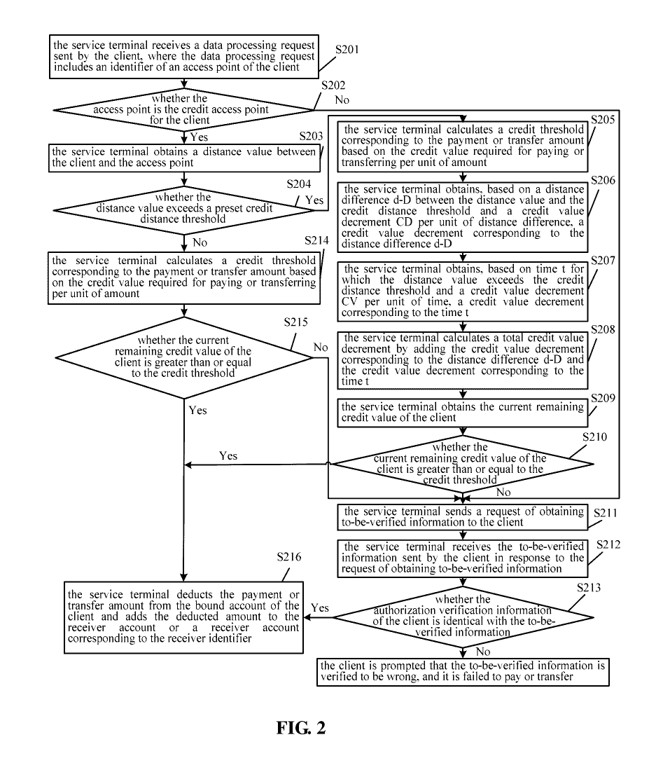

FIG. 2, which is a flowchart of a method for processing data according to another embodiment of the disclosure. The method described in FIG. 2 is applied not only to scenarios of mobile online shopping but also to scenarios of mobile online transferring. In the method described in FIG. 2, a client may grant authorization information to a service terminal in advance, the authorization information includes an identifier of the client, an identifier of a credit access point, a bound account and authorization verification information. The client granting the authorization information including the identifier of the client, the identifier of the credit access point, the bound account and the authorization verification information to the service terminal in advance may include the following steps S31 to S35.

In step S31, the client performs access point scanning in response to an inputted access point scanning instruction, to obtain information of an access point.

In the embodiment the information of the access point generally includes a name of the access point.

In the embodiment, during the process of the access point scanning, the client may start timing. In a case that information of no access point is obtained within a preset period of time after the timing is started, the client may terminate operations of the access point scanning. In a case that information of an access point is obtained within the preset period of time after the timing is started, the client may output the information of the access point, obtained within the preset period of time by the scanning, for display.

In step S32, the client detects an authorization operation inputted for the information of at least one access point, obtains an identifier of an access point corresponding to the authorized information of the access point as the identifier of the credit access point, and obtains the identifier of the client.

The authorization operation inputted for the information of at least one access point includes an operation such as authorization click or authorization double click inputted for the information of the at least one access point. The identifier of the client may include a unique name of the client, a unique account of the client or the like.

In step S33, the client prompts to input the bound account and the authorization verification information.

In step S34, the client detects the inputted bound account and the inputted authorization verification information.

, The authorization verification information above may be, for example, any one of or combination of an authorization verification password, authorization verification fingerprint information, authorization verification facial information; authorization verification iris information, authorization verification retina information and authorization verification voiceprint information.

In step S35, the client sends an authorization request including the authorization information to the service terminal, the service terminal stores the authorization information in response to the authorization request. The authorization information includes the identifier of the client, the identifier of the credit access point, the bound account and the authorization verification information.

Through steps S31 to S35 above, the client can grant the authorization information including the identifier of the client, the identifier of the credit access point, the bound account and the authorization verification information to the service terminal.

As shown in FIG. 2, the method for processing data may include the following steps S201 to S216.

In step S201, the service terminal receives a data processing request sent by the client, where the data processing request includes an identifier of an access point of the client.

The data processing request may include the identifier of the client, a payment amount (or a transfer amount) and a receiver identifier (or a receiver account).

In step S202, the service terminal determines whether the access point is the credit access point for the client. Step S203 is performed in a case that the access point is the credit access point for the client. And step S211 is performed in a case that the access point is not the credit access point for the client.

The service terminal may determine whether the identifier of the access point included in the data processing request is identical with the identifier of the credit access point for the client. In a case that the identifier of the access point included in the data processing request is identical with the identifier of the credit access point for the client, it is determined that the access point is the credit access point for the client. In a case that the identifier of the access point included in the data processing request is not identical with the identifier of the credit access point for the client, it is determined that the access point is not the credit access point for the client.

In step S203, the service terminal obtains a distance value between the client and the access point.

In an embodiment, in a case that the client and the access point each are provided with a locating function (for example, a GPS locating function), the service terminal obtaining the distance value between the client and the access point in step S203 above may include the following steps S11 to S13.

In step S11, the service terminal sends a location obtaining instruction to each of the client and the access point.

In step S12, the service terminal receives location information of the client sent by the client in response to the location obtaining instruction and location information of the access point sent by the access point in response to the location obtaining instruction.

In step S13, the service terminal calculates the distance value between the client and the access point based on the location information of the client and the location information of the access point.

The location information above may include latitude and longitude coordinates.

In another embodiment, in a case that the client can start smart distance value measuring application software, the service terminal obtaining the distance value between the client and the access point in step S203 above may include the following steps S21 and S22.

In step S21, the service terminal sends a distance value obtaining instruction to the client, to trigger the client to obtain the distance value between the client and the access point in response to the distance value obtaining instruction.

In step S22, the service terminal receives the distance value between the client and the access point sent by the client.

The client may start the smart distance value measuring application software (for example, Smart Distance) in response to the distance value obtaining instruction, to detect the distance value between the client and the access point with the smart distance value measuring application software, where Smart Distance is an application for measuring distance values with a camera.

In step S204, the service terminal determines whether the distance value exceeds a preset credit distance threshold (also called a distance threshold). Step S205 is performed in a case that the distance value exceeds the preset credit distance threshold. Step S214 is performed in a case that the distance value does not exceed the preset credit distance threshold.

The preset credit distance threshold above is set by a user of the client at the service terminal in advance (for example, the user may set the credit distance threshold by setting the credit value required for paying or transferring per unit of amount). Furthermore, the user of the client may set an initial credit value CMAX at the service terminal in advance. When the client moves in an area with the credit access point as a center and the credit distance threshold as a radius, a current remaining credit value of the client (i.e., a credit value of the user of the client) is equal to the initial credit value CMAX. When the client moves outside the area with the credit access point as the center and the credit distance threshold as the radius, the current remaining credit value of the client decreases as the distance value and time increase, i.e., the current remaining credit value of the client is less than the initial credit value CMAX in this case.

In step S205, the service terminal calculates a credit threshold corresponding to the payment or transfer amount based on the credit value required for paying or transferring per unit of amount.

, The service terminal may calculate a product of the credit value CP required for paying or transferring per unit of amount and the payment or transfer amount P as the credit threshold corresponding to the payment or transfer amount, i.e., P×CP.

In step S206, the service terminal obtains, based on a distance difference d−D between the distance value and the credit distance threshold and a credit value decrement CD per unit of distance difference, a credit value decrement corresponding to the distance difference d−D.

The credit value decrement CD per unit of distance difference may be set by a user of the client at the service terminal in advance, and the credit value decrement corresponding to the distance difference d−D is equal to (d−D)×CD.

In step S207, the service terminal obtains, based on time t for which the distance value exceeds the credit distance threshold and a credit value decrement CV per unit of time, a credit value decrement corresponding to the time t.

The credit value decrement CV per unit of time may be set by a user of the client at the service terminal in advance, and the credit value decrement corresponding to the time t is equal to t×CV.

The service terminal may calculate the time t for which the distance value exceeds the credit distance threshold based on a movement speed of the client and the distance difference d−D between the distance value and the credit distance threshold.

In another embodiment, the client may be provided with a timer for calculating the time t for which the distance value exceeds the credit distance threshold. A distance monitoring program may be installed in the client, to periodically calculate a distance value between the client and the credit access point. The timer is started to time once it is monitored that the distance value exceeds the preset credit distance threshold.

In step S208, the service terminal calculates a total credit value decrement by adding the credit value decrement corresponding to the distance difference d−D and the credit value decrement corresponding to the time t.

In step S209, the service terminal obtains the current remaining credit value of the client.

According to an another embodiment, the current remaining credit value of the client is equal to (the initial credit value CMAX−t×CV−(d−D)×CD), which means that the current remaining credit value does not decrease due to a payment or transfer operation performed.

According to a further embodiment, in a case that the distance value between the client and the access point does not exceed the preset credit distance threshold, the credit value does not decrease due to a payment or transfer operation. In a case that the distance value between the client and the access point exceeds the preset credit distance threshold, the credit value decreases due to a payment or transfer operation. For example, in a case that the distance value between the client and the access point exceeds the preset credit distance threshold and no payment or transfer operation is already performed, the current remaining credit value of the client is equal to the initial credit value of the client minus the total credit value decrement calculated in step S208, i.e., the current remaining credit value of the client is equal to (the initial credit value CMAX−t×CV−(d−D)×CD). After one payment or transfer operation is performed, the current remaining credit value of the client is equal to the initial credit value minus the total credit value decrement calculated in step S208 and further minus a credit threshold corresponding to the payment or transfer operation performed.

In step S210, the service terminal determines whether the current remaining credit value of the client is greater than or equal to the credit threshold calculated in step S205. Step S216 is performed in a case that the current remaining credit value of the client is greater than or equal to the credit threshold. Step S211 is performed in a case that the current remaining credit value of the client is less than the credit threshold.

In step S211, the service terminal sends a request of obtaining to-be-verified information to the client.

In step S212, the service terminal receives the to-be-verified information sent by the client in response to the request of obtaining to-be-verified information.

The client may prompt to input the to-be-verified information in response to the request of obtaining to-be-verified information and send the inputted to-be-verified information to the service terminal.

The to-be-verified information above may be, for example, any one of or combination of a to-be-verified password, to-be-verified fingerprint information, to-be-verified facial information, to-be-verified iris information, to-be-verified retina information and to-be-verified voiceprint information.

In step S213, the service terminal verifies whether the authorization verification information of the client is identical with the to-be-verified information. In a case that the authorization verification information of the client is identical with the to-be-verified information, step S216 is performed and then the process is terminated. In a case that the authorization verification information of the client is not identical with the to-be-verified information, the client is prompted that the to-be-verified information is verified to be wrong, and it is failed to processing the data, and then the process is terminated.

In step S214, the service terminal calculates a credit threshold corresponding to the payment or transfer amount based on the credit value required for paying or transferring per unit of amount.

, The service terminal may calculate a product of the credit value required for paying or transferring per unit of amount and the payment or transfer amount as the credit threshold.

In step S215, the service terminal determines whether the current remaining credit value of the client is greater than or equal to the credit threshold. Step S216 is performed in a case that the current remaining credit value of the client is greater than or equal to the credit threshold. Step S211 is performed in a case that the current remaining credit value of the client is less than the credit threshold.

In step S216, the service terminal deducts the payment or transfer amount from the bound account of the client and adds the deducted amount to the receiver account or a receiver account corresponding to the receiver identifier.

As can be seen that, with the method described in FIG. 2, there is no need to manually input a password to the client, which simplifies the operations and improving efficiency. In addition, with the method described in FIG. 2, the payment password can be effectively prevented from being stolen and security of the mobile payment can be improved.

Mobile online shopping or mobile online transferring is only an example of application of the method for processing data, and the method for processing data may also be applied to, for example, data transmission. For the data transmission, the service terminal may calculate a product of a credit value required for transmitting per unit of data and the quantity of to-be-transmitted data as the credit threshold.

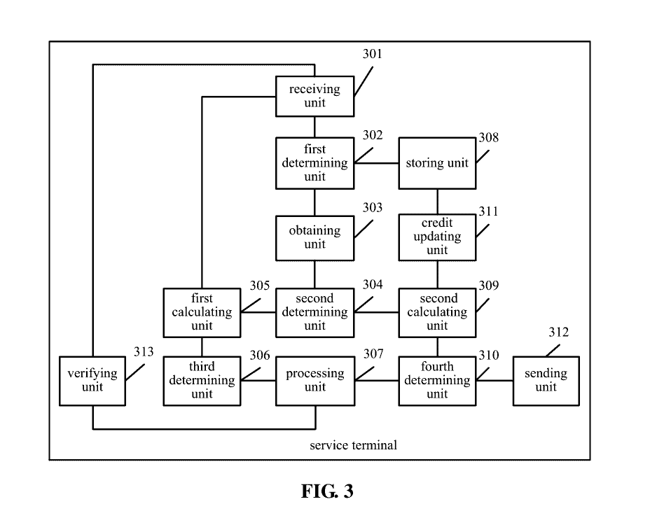

FIG. 3, is a schematic structural diagram of a service terminal according to an embodiment of the disclosure. The service terminal shown in FIG. 3 is configured to implement a method for processing data. The service terminal shown in FIG. 3 is applied not only to scenarios of mobile online shopping but also to scenarios of mobile online transferring. As shown in FIG. 3, the service terminal includes a receiving unit 301, a first determining unit 302, an obtaining unit 303, a second determining unit 304, a first calculating unit 305, a third determining unit 306 and a processing unit 307.

The receiving unit 301 is configured to receive a data processing request sent by a client, where the data processing request includes an identifier of an access point of the client.

The first determining unit 302 is configured to determine whether the access point is a credit access point for the client.

The obtaining unit 303 is configured to obtain a distance value between the client and the access point in a case that the first determining unit 302 determines that the access point is the credit access point for the client.

The second determining unit 304 is configured to determine whether the distance value exceeds a preset credit distance threshold (also called a distance threshold).

The first calculating unit 305 is configured to calculate a credit threshold corresponding to a payment or transfer amount based on a credit value required for paying or transferring per unit of amount in a case that the second determining unit 304 determines that the distance value exceeds the preset credit distance threshold.

The third determining unit 306 is configured to determine whether a current remaining credit value of the client is greater than or equal to the credit threshold, and trigger the processing unit 307 to start operating in a case that the current remaining credit value of the client is greater than or equal to the credit threshold.

The processing unit 307 is configured to deduct the payment or transfer amount from a bound account of the client and add the deducted amount to a receiver account or a receiver account corresponding to a receiver identifier.

The receiving unit 301 is further configured to receive an authorization request including authorization information sent by the client before receiving the data processing request sent by the client. The authorization information includes an identifier of the client, an identifier of the credit access point for the client and the bound account of the client.

Accordingly, the service terminal shown in FIG. 3 further includes a storing unit 308 configured to store the authorization information in response to the authorization request.

The first determining unit 302 is configured to determine whether the identifier of the access point is identical with the identifier of the credit access point for the client included in the authorization information stored in the storing unit 308, and determine that the access point is the credit access point for the client in a case that the identifier of the access point is identical with the identifier of the credit access point for the client.

The service terminal shown in FIG. 3 may further include a second calculating unit 309 and a fourth determining unit 310.

The second calculating unit 309 is configured to: in a case that the second determining unit 304 determines that the distance value exceeds the preset credit distance threshold, obtain, based on a distance difference d−D between the distance value and the credit distance threshold and a credit value decrement CD per unit of distance difference, a credit value decrement corresponding to the distance difference d−D; obtain, based on time t for which the distance value exceeds the credit distance threshold and a credit value decrement CV per unit of time, a credit value decrement corresponding to the time t; calculate a total credit value decrement by adding the credit value decrement corresponding to the distance difference d−D and the credit value decrement corresponding to the time t; calculate a difference between an initial credit value of the client and the total credit value decrement, to obtain the current remaining credit value of the client; and calculate a credit threshold corresponding to the payment or transfer amount based on the credit value required for paying or transferring per unit of amount.

The fourth determining unit 310 is configured to: determine whether the current remaining credit value of the client is greater than or equal to the credit threshold; and, in a case that the current remaining credit value of the client is greater than or equal to the credit threshold, trigger the processing unit 307 to perform the step of deducting the payment or transfer amount from the bound account of the client and adding the deducted amount to the receiver account or a receiver account corresponding to the receiver identifier.

The service terminal shown in FIG. 3 may further include a credit updating unit 311.

The credit updating unit 311 is configured to: after the second calculating unit 309 obtains the current remaining credit value of the client by calculating the difference between the initial credit value of the client and the total credit value decrement, update a memory with the current remaining credit value. That is, the current remaining credit value stored in the memory is updated as time passes.

The authorization information may further include authorization verification information of the client, and accordingly, as shown in FIG. 3, the service terminal may further include a sending unit 312 and a verifying unit 313.

The sending unit 312 is configured to send a request of obtaining to-be-verified information to the client in a case that the fourth determining unit 310 determines that the current remaining credit value of the client is less than the credit threshold.

The receiving unit 301 is further configured to receive the to-be-verified information sent by the client in response to the request of obtaining to-be-verified information.

The verifying unit 313 is configured to: verify whether the authorization verification information of the client is identical with the to-be-verified information; and, in a case that the authorization verification information of the client is identical with the to-be-verified information, trigger the processing unit 307 to perform the step of deducting the payment or transfer amount from the bound account of the client and adding the deducted amount to the receiver account or a receiver account corresponding to the receiver identifier.

The obtaining unit 303 may send a location obtaining instruction to each of the client and the access point, receive location information of the client sent by the client in response to the location obtaining instruction and location information of the access point sent by the access point in response to the location obtaining instruction, and calculate the distance value between the client and the access point based on the location information of the client and the location information of the access point.

Alternatively, the obtaining unit 303 may send a distance value obtaining instruction to the client, to trigger the client to obtain the distance value between the client and the access point in response to the distance value obtaining instruction, and receive the distance value between the client and the access point sent by the client.

As can be seen that, with the service terminal described in FIG. 3, there is no need to manually input a payment password to the client, which simplifies the operations of mobile payment and improving efficiency of the mobile payment. In addition, with the service terminal described in FIG. 3, the payment password can be effectively prevented from being stolen and security of the mobile payment can be improved.

Mobile online shopping or mobile online transferring is only an example of application of the service terminal according to the embodiment of the disclosure, and the service terminal according to the embodiment of the disclosure may also be applied to, for example, data transmission. For the data transmission, the service terminal may calculate a product of a credit value required for transmitting per unit of data and the quantity of to-be-transmitted data as the credit threshold.

FIG. 4, is a schematic structural diagram of a service terminal according to another embodiment of the disclosure. The service terminal described in FIG. 4 is applied not only to scenarios of mobile online shopping but also to scenarios of mobile online transferring. As shown in FIG. 4, the service terminal 400 may include at least one processor 401 such as a CPU, at least one network interface 402, a user interface 403, a memory 404, a database unit 405 and at least one communications bus 406. The communications bus 406 is configured to achieve connections and communications between the components. The user interface 403 may include a display, a keyboard or the like. The memory 404 may be a high-speed RAM (random access memory), or a non-volatile memory, for example, at least one disk memory. Optionally, the memory 404 may be at least one storage apparatus located far away from the processor 401 above. As shown in FIG. 4, the memory 404 which functions as a computer storage medium may include an operating system, a network communications module, a user interface module and a data processing program.

In the service terminal 400 shown in FIG. 4, the network interface 402 is mainly configured to connect to a client and perform data communications. And the processor 401 may be configured to call the data processing program stored in the memory 404 and perform the following operations:

receiving a data processing request sent by the client through the network interface 402, where the data processing request includes an identifier of an access point of the client;

determining whether the access point is a credit access point for the client; and obtaining a distance value between the client and the access point in a case that the access point is the credit access point for the client;

determining whether the distance value exceeds a preset credit distance threshold; and calculating a credit threshold corresponding to a payment or transfer amount based on a credit value required for paying or transferring per unit of amount in a case that the distance value exceeds the preset credit distance threshold; and

determining whether a current remaining credit value of the client stored in the database unit 405 is greater than or equal to the credit threshold; and deducting the payment or transfer amount from a bound account of the client stored in the database unit 405 and adding the deducted amount to a receiver account or a receiver account corresponding to a receiver identifier, in a case that the current remaining credit value of the client is greater than or equal to the credit threshold.

Before the processor 401 receives the data processing request sent by the client through the network interface 402, the processor 401 may call the data processing program stored in the memory 404 and perform the following operations:

receiving an authorization request including authorization information sent by the client through the network interface 402, where the authorization information includes an identifier of the client, an identifier of the credit access point for the client and the bound account of the client; and

storing the authorization information in the database unit 405 in response to the authorization request.

The processor 401 determining whether the access point is the credit access point includes:

determining whether the identifier of the access point is identical with the identifier of the credit access point for the client included in the authorization information stored in the database unit 405, and determining that the access point is the credit access point for the client in a case that the identifier of the access point is identical with the identifier of the credit access point for the client.

In a case that the processor 401 determines that the distance value exceeds the preset credit distance threshold, the processor 401 may call the data processing program stored in the memory 404 and perform the following operations:

obtaining, based on a distance difference d−D between the distance value and the credit distance threshold and a credit value decrement CD per unit of distance difference stored in the database unit 405, a credit value decrement corresponding to the distance difference d−D;

obtaining, based on time t for which the distance value exceeds the credit distance threshold and a credit value decrement CV per unit of time stored in the database unit 405, a credit value decrement corresponding to the time t;

calculating a total credit value decrement by adding the credit value decrement corresponding to the distance difference d−D and the credit value decrement corresponding to the time t;

calculating a difference between an initial credit value of the client stored in the database unit 405 and the total credit value decrement, to obtain the current remaining credit value of the client;

calculating the credit threshold corresponding to the payment or transfer amount based on the credit value required for paying or transferring per unit of amount stored in the database unit 405; and

determining whether the current remaining credit value of the client is greater than or equal to the credit threshold; and, in a case that the current remaining credit value of the client is greater than or equal to the credit threshold, performing the step of deducting the payment or transfer amount from the bound account of the client stored in the database unit 405 and adding the deducted amount to the receiver account or a receiver account corresponding to the receiver identifier.

After the processor 401 obtains the current remaining credit value of the client by calculating the difference between the initial credit value of the client stored in the database unit 405 and the total credit value decrement, the processor 401 may call the data processing program stored in the memory 404 and perform the following operation:

updating the database unit 405 with the current remaining credit value.

The authorization information above may further include authorization verification information of the client. In a case that the processor 401 determines that the current remaining credit value of the client is less than the credit threshold, the processor 401 may call the data processing program stored in the memory 404 and perform the following operations:

sending a request of obtaining to-be-verified information to the client through the network interface 402;

receiving, through the network interface 402, the to-be-verified information sent by the client in response to the request of obtaining to-be-verified information; and
verifying whether the authorization verification information of the client stored in the database unit 405 is identical with the to-be-verified information; and, in a case that the authorization verification information of the client is identical with the to-be-verified information, performing the step of deducting the payment or transfer amount from the bound account of the client stored in the database unit 405 and adding the deducted amount to the receiver account or a receiver account corresponding to the receiver identifier.

In another embodiment, the processor 401 obtaining the distance value between the client and the access point may include:

sending a location obtaining instruction to each of the client and the access point through the network interface 402;

receiving, through the network interface 402, location information of the client sent by the client in response to the location obtaining instruction and location information of the access point sent by the access point in response to the location obtaining instruction; and

calculating the distance value between the client and the access point based on the location information of the client and the location information of the access point.

In yet another embodiment, the processor 401 obtaining the distance value between the client and the access point may include:

sending a distance value obtaining instruction to the client through the network interface 402, to trigger the client to obtain the distance value between the client and the access point in response to the distance value obtaining instruction; and

receiving, through the network interface 402, the distance value between the client and the access point sent by the client.

As can be seen that, with the service terminal described in FIG. 4, there is no need to manually input a payment password to the client, which simplifies the operations of mobile payment and improving efficiency of the mobile payment. In addition, with the service terminal described in FIG. 4, the payment password can be effectively prevented from being stolen and security of the mobile payment can be improved.

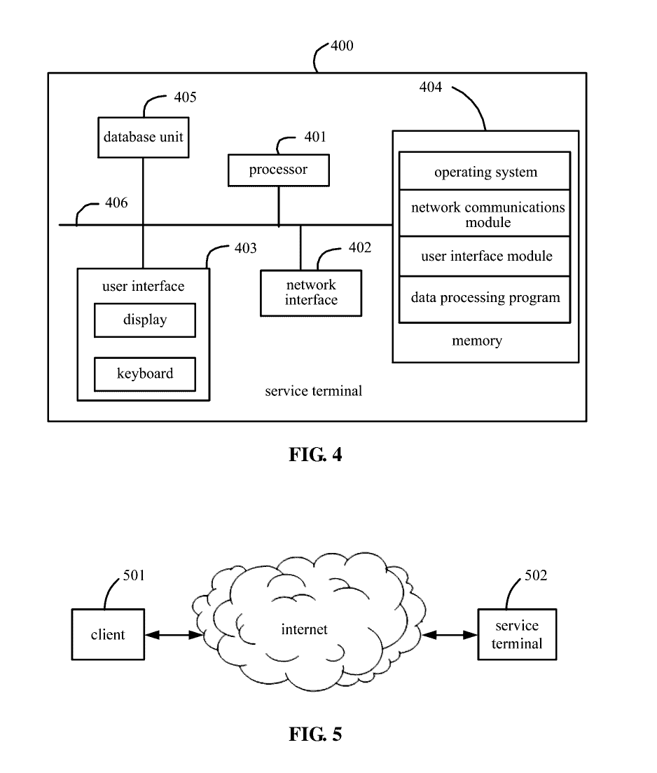

FIG. 5 is a schematic structural diagram of a system for processing data according to an embodiment. The system described in FIG. 5 is applied not only to scenarios of mobile online shopping but also to scenarios of mobile online transferring. As shown in FIG. 5, the system may include a client 501 and a service terminal 502, where the client 501 and the service terminal 502 communicate with each other through a network (for example, the internet).

The client 501 is configured to send a data processing request to the service terminal 502.

The service terminal 502 is configured to receive the data processing request sent by the client 501, where the data processing request includes an identifier of an access point of the client 501.

The service terminal 502 is further configured to: determine whether the access point is a credit access point for the client 501; and, in a case that the access point is the credit access point for the client 501, obtain a distance value between the client 501 and the access point.

The service terminal 502 is further configured to: determine whether the distance value exceeds a preset credit distance threshold; and, in a case that the distance value exceeds the preset credit distance threshold, calculate a credit threshold corresponding to a payment or transfer amount based on a credit value required for paying or transferring per unit of amount.

The service terminal 502 is further configured to: determine whether a current remaining credit value of the client 501 is greater than or equal to the credit threshold; in a case that the current remaining credit value is greater than or equal to the credit threshold, deduct the payment or transfer amount from a bound account of the client 501 and add deducted amount to a receiver account or a receiver account corresponding to a receiver identifier.

In the system for processing data as described in FIG. 5:

the client 501 is further configured to send an authorization request including authorization information to the service terminal 502 before the client 501 sends the data processing request to the service terminal 502;

the service terminal 502 is further configured to receive the authorization request including the authorization information sent by the client 501 before receiving the data processing request sent by the client 501, where the authorization information includes an identifier of the client 501, an identifier of the credit access point for the client 501 and the bound account of the client 501; and

the service terminal 502 is further configured to store the authorization information in response to the authorization request.

The service terminal 502 determining whether the access point is the credit access point for the client 501 includes:

determining, by the service terminal 502, whether the identifier of the access point is identical with the identifier of the credit access point for the client 501 included in the authorization information; and determining, by the service terminal 502, that the access point is the credit access point for the client 501 in a case that the identifier of the access point is identical with the identifier of the credit access point for the client 501.

In the system for processing data as shown in FIG. 5:

the service terminal 502 is further configured to: obtain, based on a distance difference d−D between the distance value and the preset credit distance threshold and a credit value decrement CD per unit of distance difference, a credit value decrement corresponding to the distance difference d−D, in a case that it is determined the distance value exceeds the preset credit distance threshold;

the service terminal 502 is further configured to obtain, based on time t for which the distance value exceeds the credit distance threshold and a credit value decrement CV per unit of time, a credit value decrement corresponding to the time t;

the service terminal 502 is further configured to calculate a total credit value decrement by adding the credit value decrement corresponding to the distance difference d−D and the credit value decrement corresponding to the time t;

the service terminal 502 is further configured to calculate a difference between an initial credit value of the client 501 and the total credit value decrement, to obtain the current remaining credit value of the client 501;

the service terminal 502 is further configured to calculate the credit threshold corresponding to the payment or transfer amount based on the credit value required for paying or transferring per unit of amount; and

the service terminal 502 is further configured to: determine whether the current remaining credit value of the client 501 is greater than or equal to the credit threshold; and, in a case that the current remaining credit value of the client 501 is greater than or equal to the credit threshold, perform the step of deducting the payment or transfer amount from the bound account of the client 501 and adding the deducted amount to the receiver account or the receiver account corresponding to the receiver identifier.

In an embodiment of the system for processing data as shown in FIG. 5:

the service terminal 502 is further configured to: after obtaining the current remaining credit value of the client 501 by calculating the difference between the initial credit value of the client 501 and the total credit value decrement, update a memory or a database with the current remaining credit value.

In an embodiment of the system for processing data as shown in FIG. 5, the authorization information further includes authorization verification information of the client 501, where:

the service terminal 502 is further configured to send a request of obtaining to-be-verified information to the client 501 in a case that a latest remaining credit value of the client 501 is less than the credit threshold corresponding to a quantity of to-be-processed data;

the client 501 is further configured to send the to-be-verified information inputted in response to the request of obtaining to-be-verified information to the service terminal; and

the service terminal 502 is further configured to: verify whether the authorization verification information of the client 501 is identical with the to-be-verified information; and, in a case that the authorization verification information of the client 501 is identical with the to-be-verified information, perform the step of deducting the payment or transfer amount from the bound account of the client 501 and adding the deducted amount to the receiver account or the receiver account corresponding to the receiver identifier.

In the system for processing data as shown in FIG. 5, the service terminal 502 obtaining the distance value between the client 501 and the access point may include:

the service terminal 502 sending a location obtaining instruction to each of the client 501 and the access point;

the service terminal 502 receiving location information of the client 501 sent by the client 501 in response to the location obtaining instruction and location information of the access point sent by the access point in response to the location obtaining instruction; and the service terminal 502 calculating the distance value between the client 501 and the access point based on the location information of the client 501 and the location information of the access point.

In the system for processing data as shown in FIG. 5, the service terminal 502 obtaining the distance value between the client 501 and the access point may include:

the service terminal 502 sending a distance value obtaining instruction to the client 501, to trigger the client 501 to obtain the distance value between the client 501 and the access point in response to the distance value obtaining instruction; and

the service terminal 502 receiving the distance value between the client 501 and the access point sent by the client 501.

As can be seen that, with the system of FIG. 5, there is no need to manually input a payment password to the client, which simplifies the operations of mobile payment and improving efficiency of the mobile payment. In addition, with the system described in FIG. 5, the payment password can be effectively prevented from being stolen and security of the mobile payment can be improved.

In the embodiments of the disclosure, the client may also called payment client or payment device, and a means by which the client and the credit access point communicate with each other is not limited to Wi-Fi, other means such as NFC may be adopted.

The identifier (for example, an MAC address) of the access point is merely used to identify an identity of the access point, and other information of the access point, which can function as a unique identity identifier, for example, a machine identification code, may be used as the identifier of the access point.

The credit access point in the embodiment of the disclosure may be, but not limited to, a home wireless router or an on-board wireless router.

Those skilled in the art will understand that all or some of the steps of the methods according to the embodiments above may be performed through hardware under the instruction of a program, where the program may be stored in a computer readable storage medium which may include a read-only memory (ROM), a random access memory (RAM), a programmable read-only memory (PROM), an erasable programmable read-only memory (EPROM), a one-time programmable read-only memory (OTPROM), an electrically-erasable programmable read-only memory (EEPROM), a compact disc read-only memory (CD-ROM), any other disc memory, a disk memory, a tape memory or any other computer readable medium which can carry or store data.

The method and the apparatus for processing data according to the embodiments of the present disclosure are described in detail above. The principle and implementations of the disclosure are described through some specific embodiments, and the descriptions of the embodiments above are only for understanding the method of the disclosure and the core idea thereof. And, modifications may be made on specific implementations and the application scope of the disclosure by those skilled in the art within the spirit of the disclosure. In summary, the specification should not be interpreted as a limit to the claims.

What is claimed is:

1. A method for processing data, comprising:
receiving, by a second device through a network, a data processing request sent by a first device, wherein the first device is connected to the network via a wireless access point;
determining whether the wireless access point is a credit access point for the first device;
obtaining a distance value between the first device and the wireless access point in a case that the wireless access point is the credit access point for the first device;
determining whether the distance value exceeds a preset distance threshold;
calculating, based on the distance value between the first device and the wireless access point, a credit value associated with the first device in a case that the distance value exceeds the preset distance threshold;
determining whether the credit value is greater than or equal to a credit threshold; and
accepting, by the second device, a request to process data in a case that the credit value is greater than or equal to the credit threshold.

2. The method according to claim 1, further comprising: receiving an authorization request which is sent by the first device and comprises authorization information, wherein the authorization information comprises an identifier of the credit access point,
wherein determining whether the wireless access point is the credit access point comprises:
obtaining an identifier of the wireless access point; and
determining whether the identifier of the wireless access point is identical with the identifier of the credit access point.

3. The method according to claim 2, wherein the credit value associated with the first device is a credit value of a user of the first device, and the authorization information further comprises an identifier of the user and an identifier of the first device.

4. The method according to claim 1, wherein:
the credit value decreases as the distance value between the first device and the wireless access point increases, in a case that the distance value exceeds the preset distance threshold; and/or
the credit value decreases as time passes in a case that the distance value exceeds the preset distance threshold.

5. The method according to claim 1, wherein calculating the credit value associated with the first device comprises:
obtaining, based on a distance difference d−D between the distance value and the preset distance threshold and a credit value decrement CD per unit of distance difference, a credit value decrement corresponding to the distance difference d−D;
obtaining, based on a time t for which the distance value exceeds the preset distance threshold and a credit value decrement CV per unit of time, a credit value decrement corresponding to the time t; and
obtaining the credit value associated with the first device by subtracting the credit value decrement corresponding to the distance difference d−D and the credit value decrement corresponding to the time t from a preset initial credit value.

6. The method according to claim 1, wherein the data is account data of a user of the first device, the account data comprises a number, the data processing request comprises a variation amount of the number, and a magnitude of the credit threshold is proportional to the variation amount of the number.

7. The method according to claim 1, wherein, in a case that the credit value is less than the credit threshold, the method further comprises:
sending a request for obtaining to-be-verified information to the first device;
receiving the to-be-verified information sent by the first device;
performing verification on the to-be-verified information; and
processing, by the second device, the data in a case that the to-be-verified information passes the verification.

8. The method according to claim 1, wherein obtaining the distance value between the first device and the wireless access point comprises:
sending a location obtaining instruction to each of the first device and the wireless access point;
receiving location information of the first device sent by the first device in response to the location obtaining instruction and location information of the wireless access point sent by the wireless access point in response to the location obtaining instruction; and
calculating the distance value between the first device and the wireless access point based on the location information of the first device and the location information of the wireless access point.

9. The method according to claim 1, wherein obtaining the distance value between the first device and the wireless access point comprises:
sending a distance value obtaining instruction to the first device, to trigger the first device to obtain the distance value between the first device and the wireless access point in response to the distance value obtaining instruction; and
receiving the distance value between the first device and the wireless access point sent by the first device.

10. An apparatus for processing data, comprising a memory and one or more processors,
wherein program instructions are stored in a non-volatile computer readable memory, and when the program instructions are executed by the one or more processors, the program instructions configure the apparatus to perform operations comprising:
receiving, through a network, a data processing request sent by a first device, wherein the first device is connected to the network via a wireless access point;
determining whether the wireless access point is a credit access point for the first device;
obtaining a distance value between the first device and the wireless access point in a case that the wireless access point is the credit access point for the first device;
determining whether the distance value exceeds a preset distance threshold;
calculating, based on the distance value between the first device and the wireless access point, a credit value associated with the first device in a case that the distance value exceeds the preset distance threshold;
determining whether the credit value is greater than or equal to a credit threshold; and
accepting the data processing request in a case that the credit value is greater than or equal to the credit threshold.

11. The apparatus according to claim 10, wherein the operations further comprise receiving an authorization request which is sent by the first device and comprises authorization information, wherein the authorization information comprises an identifier of the credit access point,
wherein determining whether the wireless access point is the credit access point comprises:
obtaining an identifier of the wireless access point; and
determining whether the identifier of the wireless access point is identical with the identifier of the credit access point.

12. The apparatus according to claim 11, wherein the credit value associated with the first device is a credit value of a user of the first device, and the authorization information further comprises an identifier of the user and an identifier of the first device.

13. The apparatus according to claim 10, wherein:
the credit value decreases as the distance value between the first device and the wireless access point increases, in a case that the distance value exceeds the preset distance threshold; and/or
the credit value decreases as time passes in a case that the distance value exceeds the preset distance threshold.

14. The apparatus according to claim 10, wherein calculating the credit value associated with the first device comprises:
obtaining, based on a distance difference d−D between the distance value and the preset distance threshold and a credit value decrement CD per unit of distance difference, a credit value decrement corresponding to the distance difference d−D;
obtaining, based on a time t for which the distance value exceeds the preset distance threshold and a credit value decrement CV per unit of time, a credit value decrement corresponding to the time t; and
obtaining the credit value associated with the first device by subtracting the credit value decrement corresponding to the distance difference d−D and the credit value decrement corresponding to the time t from a preset initial credit value.

15. The apparatus according to claim 10, wherein the data is account data of a user of the first device, the account data comprises a number, the data processing request comprises a variation amount of the number, and a magnitude of the credit threshold is proportional to the variation amount of the number.

16. The apparatus according to claim 10, wherein, in a case that the credit value is less than the credit threshold, the operations further comprise:
sending a request of obtaining to-be-verified information to the first device;
receiving the to-be-verified information sent by the first device;
performing verification on the to-be-verified information; and
processing, the data in a case that the to-be-verified information passes the verification.

17. The apparatus according to claim 10, wherein obtaining the distance value between the first device and the wireless access point comprises:
sending a location obtaining instruction to each of the first device and the wireless access point;
receiving location information of the first device sent by the first device in response to the location obtaining instruction and location information of the wireless access point sent by the wireless access point in response to the location obtaining instruction; and
calculating the distance value between the first device and the wireless access point based on the location information of the first device and the location information of the wireless access point.

18. The apparatus according to claim 10, wherein obtaining the distance value between the first device and the wireless access point comprises:
sending a distance value obtaining instruction to the first device, to trigger the first device to obtain the distance value between the first device and the wireless access point in response to the distance value obtaining instruction; and
receiving the distance value between the first device and the wireless access point sent by the first device.

19. A non-transitory computer readable storage medium storing program instructions, wherein, when the program instructions are executed by a processor of a computation apparatus, the program instructions configure the computation apparatus to perform operations comprising:
receiving, through a network, a data processing request sent by a first device, wherein the first device is connected to the network via a wireless access point;
determining whether the wireless access point is a credit access point for the first device;
obtaining a distance value between the first device and the wireless access point in a case that the wireless access point is the credit access point for the first device;
determining whether the distance value exceeds a preset distance threshold;
calculating, based on the distance value between the first device and the wireless access point, a credit value associated with the first device in a case that the distance value exceeds the preset distance threshold;
determining whether the credit value is greater than or equal to a credit threshold; and
accepting the data processing request in a case that the credit value is greater than or equal to the credit threshold.

20. The non-temporary computer readable storage medium according to claim 19, wherein:
the credit value decreases as the distance value between the first device and the wireless access point increases, in a case that the distance value exceeds the preset distance threshold; and/or
the credit value decreases as time passes in a case that the distance value exceeds the preset distance threshold.
